(19) United States
(12) Patent Application Publication
(10) Pub. No.: US 2006/0131141 A1
(43) Pub. Date: Jun. 22, 2006

(54) Composite cover with electrical bridge

(76) Inventors: Kerry D Hinson, Buchanan, TN (US); Mark W Dixon, Paris, TN (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/524,185

(22) PCT Filed: Aug. 14, 2003
(86) PCT No.: PCT/US03/25728

§ 371 Date: Oct. 11, 2005

Related U.S. Application Data
(60) Provisional application No. 60/403,702, filed on Aug. 15, 2002.

(51) Int. Cl. H01H 19/00

(52) U.S. Cl. 200/6 R

(57) ABSTRACT

A composite cover made of non-conductive material includes a body or housing with an integrally formed electrical connector. The cover can be mounted to a base component to define a sealed enclosure between the base component and the housing. The electrical connector includes one or more electrical leads that extend through the housing for allowing electrical energy to pass from an electrical source outside the body to an electrical device within the enclosure, thereby forming an electrical bridge between the electrical source and the electrical device.

### BACKGROUND OF THE INVENTION

1. Field of the Invention

The invention relates in general to a sealed cover that allows an electrical connection between the inside of the cover and the outside of the cover. In particular, the invention relates to a composite cover with an integrally formed electrical connector to form an electrical bridge between an electrical device inside the cover and an electrical source outside the cover.

2. Description of the Related Art

Typically, a sealed ever with electrical connectors for allowing an electrical connection between the inside of the cover and the outside of the cover required holes in the cover through which wiring connectors are assembled with sealing grommets or bulk dispensed sealers. Prior connectors are disclosed in U.S. Pat. No. 6,416,341, to Platz, and German Patent No. DE 43 40 280 A1 to Doduco GmbH.

### SUMMARY OF THE INVENTION

A composite cover with an electrical bridge is disclosed. The cover comprises a base component and a housing mounted to the base component defining an enclosure therein. Preferably, the housing made of nonconductive material. At least one electrical connector is integrally formed with the housing. The electrical connector including one or more electrical leads that extend through the housing for allowing electrical energy to pass from an electrical source outside the housing to an electrical device within the enclosure, thereby forming an electrical bridge between the electrical source and the electrical device.

### BRIEF DESCRIPTION OF THE DRAWINGS

In the drawings:

FIG. 1 is a diagrammatic cross-section of a composite cover with an electrical bridge according to an embodiment of the invention;

FIG. 2 shows a cutaway perspective view of a valve cover with an electrical bridge according to the principles of the invention;

FIG. 3 shows an exploded perspective view of a transmission oil pan with an electrical bridge according the principles of the invention; and

FIG. 4 shows a perspective view of the transmission oil pan of FIG. 3.

### DESCRIPTION OF THE PREFERRED EMBODIMENT

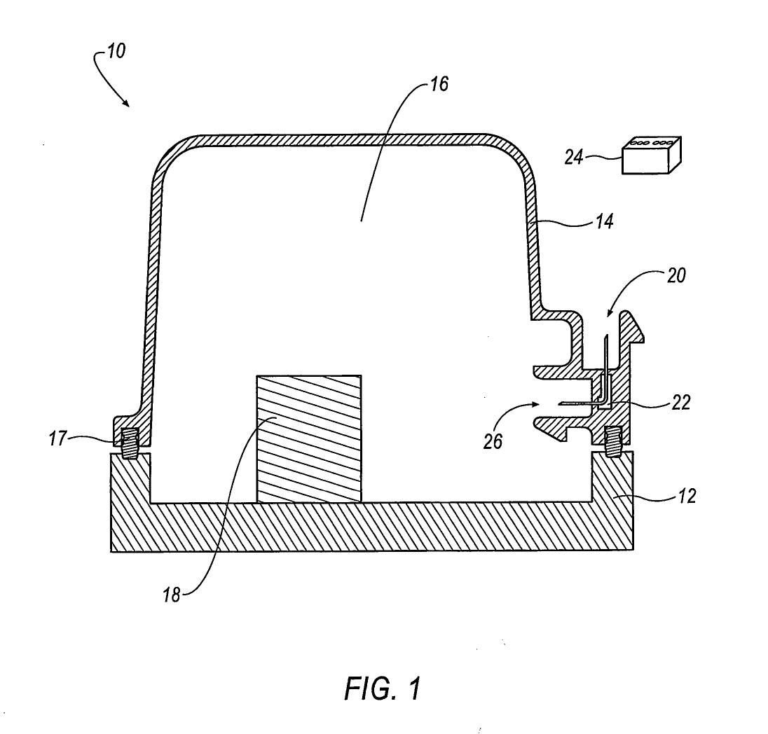

Referring now to FIG. 1, a composite cover with an electrical bridge is shown according to an embodiment of the invention. The composite cover, shown generally at 10, is usually mounted to a base component 12. The composite cover 10 includes a cover wall or housing 14 defining an enclosure 16 for housing at least one electrical device 18 within the housing 14. The composite cover 10 is preferably made of non-conductive material, such as plastic, rubber, or the like. The base component 12 may be made of the same material as the cover 10, or alternatively can be made of conductive material, such as metal, or the like. A seal 17 of a type well-known in the art may be used to mount the housing 14 to the base component 12 such that the enclosure 16 forms a sealed enclosure.

The housing 14 includes one or more electrical connectors 20 that are preferably integrally formed with the housing 14. The electrical connectors 20 can be integrally formed with the housing 14 by using any known molding technique, such as injection molding, or the like. Each electrical connector 20 includes one or more electrical leads 22 made of electrically conductive material extending through the housing 14. The purpose of the electrical connector 20 is to provide an electrical bridge between an electrical source 24 that is located outside the housing 14 and the electrical device 18 that is located within the enclosure 16 of the housing 14 to allow electrical current to flow to/from the electrical device 18. Thus, an electrical signal can pass either way through the electrical bridge depending on the application. Preferably, each electrical connector 20 is accessible from outside the housing 14 for easy connection to the electrical source 24. However, it will be appreciated that the invention is not limited by the configuration of the electrical connector 20, and that the invention can be practiced with any desirable configuration of electrical connector 20 that is adapted to provide a suitable electrical connection between the electrical source 24 and the electrical device 18.

Another electrical connector 26 may be integrally formed with the housing 114 so as to be accessible within the enclosure 16 for facilitating the electrical connection between the electrical source 24 outside the housing 14 and the electrical device 18 within the enclosure 16. To this end, the electrical connector 26 may have an identical number of electrical leads 22 as the electrical connector 20, or alternatively can have a different number of electrical leads 22, depending on the intended purpose of the electrical connection between the electrical device 18 and the electrical source 24.

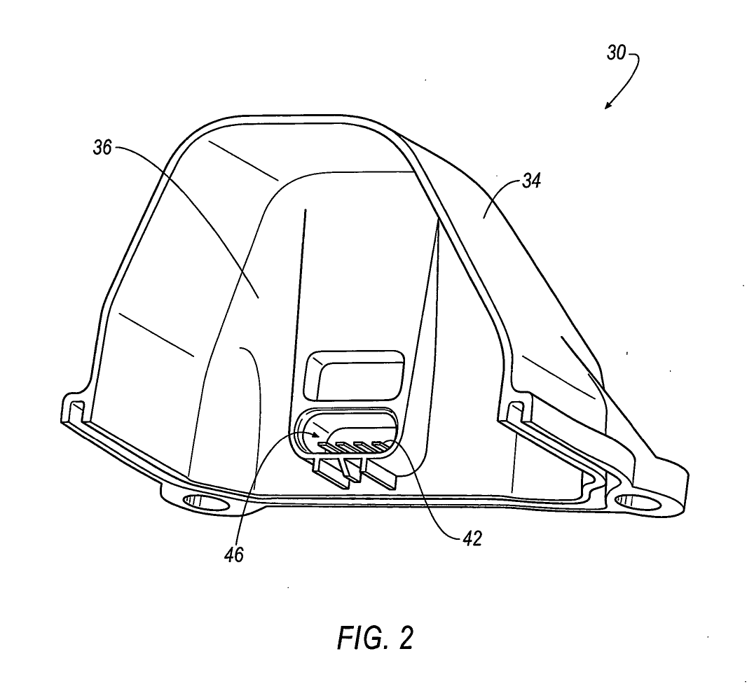

The principles of the invention can be practiced in many different applications. For example, one application in which the principles of the invention can be practiced is for a valve cover for an internal combustion engine of a vehicle, as shown in FIG. 2. The composite cover or valve cover 30 can be mounted to a base component (not shown), such as a cylinder head of an internal combustion engine. The valve cover 30 can be made of non-conductive, material, such as plastic, rubber, or the like. The valve cover 30 includes a cover wall or housing 34 defining an enclosure 36 for housing at least one electrical device (not shown) within the housing 34. The valve cover 30 is preferably made of non-conductive material, such as plastic, rubber, or the like. The housing 34 may be mounted to the cylinder head of the internal combustion engine such that the enclosure 36 is sealed. In the illustrated embodiment, the electrical connector 46 located within the enclosure 36 includes one or more leads 42 that are adapted to receive a wiring harness (not shown) of a type well-known in the art. However, the electrical connector 46 can be connected to the electrical device using any well-known means in the art. Although an electrical connector 40 integrally formed on the housing 34 so as to be accessible on the outside of the housing 34 is not shown in FIG. 2, the electrical connector 40 can be identical or different than the electrical connector 46.

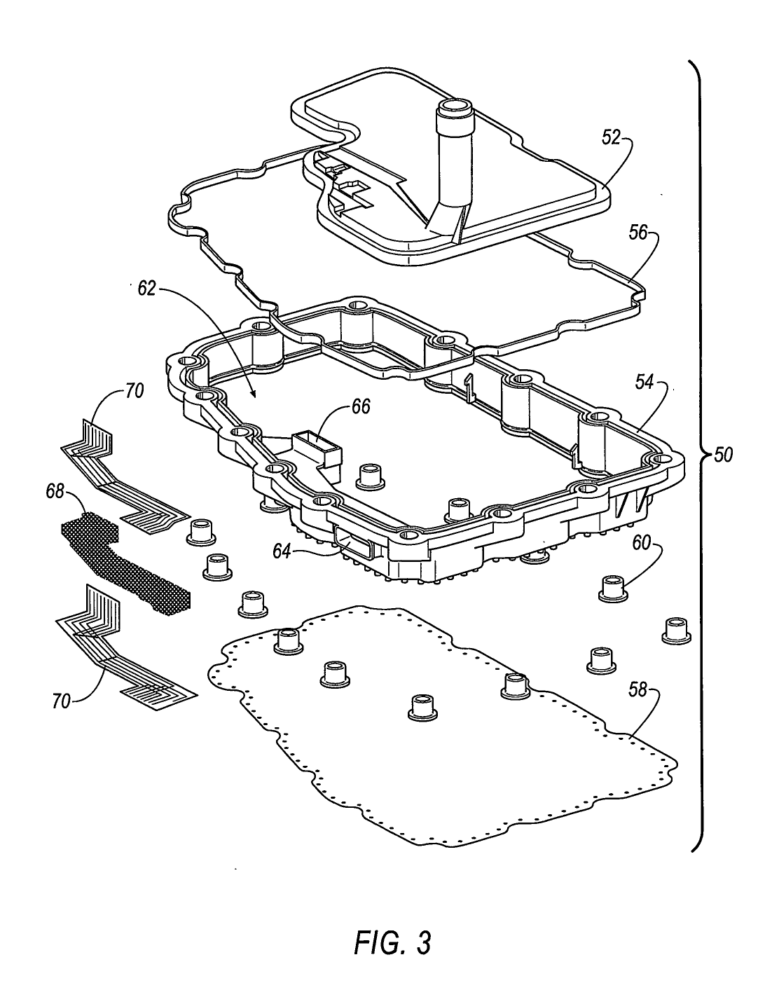

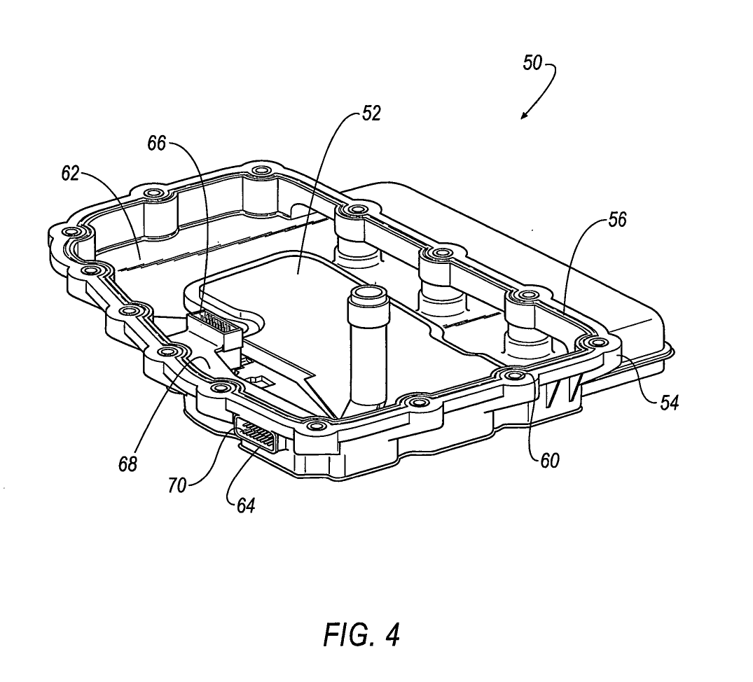

In another application, the principles of the invention can be practiced in a transmission oil pan for a vehicle, as shown in FIGS. 3 and 4. The oil pan, shown generally at 50, includes a fluid filter 52 and a bottom pan flange 54 that can be sealed by a flange gasket 56. The bottom pan flange 54 may be made of non-conductive material, such as plastic, rubber, or the like. A bottom pan closure 58 can be attached to the bottom pan flange 54 by a plurality of load limiters 60. A sealed enclosure 62 within the bottom pan flange 54 is defined by attaching the oil pan 50 to a vehicle structure (not shown), such as a transmission, or the like.

An electrical connector 64 can be integrally formed on the bottom pan flange 54 so as to be accessible from outside the oil pan 50. Similarly, an electrical connector 66 can be integrally formed on the bottom pan flange 54 so as to be accessible from inside the oil pan 50. A premold 68 can be positioned along the periphery of the bottom pan flange 54 for supporting one or more electrical leads 70 that extend from the electrical connector 64 to the electrical connector 66. The electrical leads 70 can be positioned above or below the premold 68, as shown in FIG. 3.

As described above, a composite cover with an electrical bridge allows electrical current to flow from an electrical source outside the cover to an electrical device inside the enclosure within the cover. The electrical bridge comprises an electrical connector accessible from outside the cover and inside the cover having one or more electrical leads passing through the cover. In the case of a sealed enclosure, the invention provides an electrical bridge without the needs of holes through the sealed cover, thereby reducing the risk of contaminants entering the sealed enclosure and increasing the reliability of the electrical device housed within the sealed enclosure.

While the invention has been specifically described in connection with certain specific embodiments thereof, it is to be understood that this is by way of illustration and not of limitation, and the scope of the appended claims should be construed as broadly as the prior art will permit.

1. A composite cover (10) with an electrical bridge (22), comprising:
a base component (12);
a housing (14) mounted to the base component (12) defining an enclosure (16) (16) therein, the housing (14) made of non-conducive material,
at least one electrical connector (20) integrally formed with the housing (14), the at least one electrical connector (20) including one or more electrical leads (22) that extend through the housing (14) for allowing electrical energy to pass from an electrical source outside the housing (14) to an electrical device (18) within the enclosure (16), thereby forming an electrical bridge (22) between the electrical source and the electrical device (18), wherein the electrical bridge (22) does not extend along an exposed surface of the housing (14).

2. The cover (10) according to claim 1, further comprising a seal (17) disposed between the base component (12) and the housing (14).

3. The cover (10) according to claim 1, wherein the housing (14) made of non-conductive material.

4. The cover (10) according to claim 1, wherein the cover (10) comprises a valve cover (30) for an internal combustion engine of a vehicle.

5. The cover (10) according to claim 4, wherein the base component (12) comprises a cylinder head of the internal combustion engine.

6. The cover (10) according to claim 1, wherein the cover (10) comprises an oil pan (50).

7. The cover (10) according to claim 6, wherein the housing (14) comprises a bottom pan flange (54).

8. The cover (10) according to claim 7, ether comprising a premold (68) positioned along a periphery of the bottom pan flange (54).

9. The cover (10) according to claim 7, further comprising a gasket (56) disposed between the bottom pan flange (54) and a fluid filter (52).

10. The cover (10) according to claim 6, wherein the base component (12) comprises a transmission.
